(19) United States
(12) Patent Application Publication
(10) Pub. No.: US 2014/0101621 A1
(43) Pub. Date: Apr. 10, 2014

(54) MOBILE TERMINAL BROWSER PAGE REFRESHING METHODS AND MOBILE TERMINALS

(71) Applicant: TENCENT TECHNOLOGY (SHENZHEN) COMPANY LIMITED, Shenzhen (CN)

(72) Inventors: ZHOU ZHU, Shenzhen (CN); YINGYUAN CAI, Shenzhen (CN)

(73) Assignee: TENCENT TECHNOLOGY (SHENZHEN) COMPANY LIMITED, Shenzhen (CN)

(21) Appl. No.: 14/102,725

(22) Filed: Dec. 11, 2013

Related U.S. Application Data
(63) Continuation of application No. PCT/CN2013/084125, filed on Sep. 24, 2013.

(30) Foreign Application Priority Data
Sep. 25, 2012 (CN) 201210361411.4

(51) Int. Cl. G06F 3/01

(52) U.S. Cl. CPC G06F 3/017
USPC 715/863

(57) ABSTRACT

Methods and mobile terminals for refreshing a page in a browser on a mobile terminal are provided herein. In an exemplary method, an external shake instruction can be received from a user. According to the shake instruction, acceleration values of the mobile terminal can be obtained. When at least one of the acceleration values of the mobile terminal exceeds a preset threshold value, the page in the browser on the mobile terminal can be refreshed.

### CROSS-REFERENCES TO RELATED APPLICATIONS

This application is a continuation application of PCT Patent Application No. PCT/CN2013/084125, filed on Sep. 24, 2013, which claims priority to Chinese Patent Application No. 201210361411.4, filed on Sep. 25, 2012, the entire contents of all of which are incorporated herein by reference.

### FIELD OF THE DISCLOSURE

The present disclosure generally relates to mobile communication technology and, more particularly, relates to mobile terminal browser page refreshing methods and mobile terminals.

### BACKGROUND

In a browser, a commonly-used feature set usually includes functions of page refreshing, back, forward, back to home page, opening multiple windows, expanding a toolbar, pausing, and bookmarking, etc. Usually the functional buttons for those functions are placed at the most frequently-used locations on a page in the browser. Among them, a refresh button, as a relatively frequently-used functional button, usually has a penetration rate of above 10%.

Nowadays, the refresh button is usually placed in an expandable toolbar at the bottom of the page in the browser. The four buttons of back, forward, back to home page, and opening multiple windows, are placed in a non-expandable toolbar, because those four buttons are most frequently used, in comparison with other buttons.

Because the refresh button is usually placed in the expandable toolbar at the bottom of the page in the browser, the operation of clicking the refresh button can be complicated and may need at least two clicks to be accomplished. For some websites that need frequent refreshing (such as microblogs, forums, etc.), the usage can be very inconvenient.

In view of the above situation, in some cases, some browsers use a more direct setting method. In such a method, a page address bar is fixed at the top of the browser. According to that method, a refreshing operation and a page URL (Uniform/Universal Resource Locator) have a certain corresponding relationship. Thus, it is easy for users to comprehend, and can ensure that the users can use the refreshing operation at any time.

However, this method also has some drawbacks. First, the refresh button is set at the top of the page, so the operation can be inconvenient. Especially for some large-screen mobile phones, a normal posture of holding a mobile phone cannot cover the position of the top address bar. Therefore, two hands are simultaneously needed for the operation. Second, the method only applies to browsers that have the top address bar, so cannot be implemented on browsers that do not have the top address bar.

### BRIEF SUMMARY OF THE DISCLOSURE

According to various embodiments, there is provided a method for refreshing a page in a browser on a mobile terminal. An exemplary method can be implemented by the mobile terminal. In the exemplary method, an external shake instruction can be received from a user. According to the shake instruction, acceleration values of the mobile terminal can be obtained. When at least one of the acceleration values of the mobile terminal exceeds a preset threshold value, the page in the browser on the mobile terminal can be refreshed.

According to various embodiments, there is also provided a mobile terminal for refreshing a page in a browser. The mobile terminal can include, e.g., a receiving module, an obtaining module, and a refreshing module. The receiving module can be configured to receive an external shake instruction from a user. The obtaining module can be configured to obtain acceleration values of the mobile terminal according to the shake instruction. The refreshing module can be configured to refresh the page in the browser on the mobile terminal when at least one of the acceleration values of the mobile terminal exceeds a preset threshold value.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary method for refreshing a page in a browser on a mobile terminal in accordance with various disclosed embodiments;

FIG. 2 depicts a flow diagram of obtaining acceleration values of a mobile terminal according to a shake instruction, in an exemplary method for refreshing a page in a browser on a mobile terminal in accordance with various disclosed embodiments;

FIG. 3 depicts a flow diagram of refreshing a current page in a browser on a mobile terminal when one of acceleration values of the mobile terminal exceeds a preset threshold, in an exemplary method for refreshing the page in the browser on the mobile terminal in accordance with various disclosed embodiments;

FIG. 4 depicts a flow diagram of another exemplary method for refreshing a page in a browser on a mobile terminal in accordance with various disclosed embodiments;

FIG. 5 depicts a structure diagram of an exemplary mobile terminal for refreshing a page in a browser in accordance with various disclosed embodiments;

FIG. 6 depicts a structure diagram of an obtaining module of an exemplary mobile terminal for refreshing a page in a browser in accordance with various disclosed embodiments;

FIG. 7 depicts a structure diagram of a refreshing module of an exemplary mobile terminal for refreshing a page in a browser in accordance with various disclosed embodiments;

FIG. 8 depicts a structure diagram of another exemplary mobile terminal for refreshing a page in a browser in accordance with various disclosed embodiments;

FIG. 9 depicts an exemplary environment incorporating certain disclosed embodiments; and

FIG. 10 depicts an exemplary computing system consistent with the disclosed embodiments.

### DETAILED DESCRIPTION

Reference will now be made in detail to exemplary embodiments of the disclosure, which are illustrated in the accompanying drawings.

FIG. 9 depicts an exemplary environment 900 incorporating the exemplary methods and mobile terminals in accordance with various disclosed embodiments. As shown in FIG. 9, the environment 900 can include a server 904, a terminal 906, and a communication network 902. The server 904 and the terminal 906 may be coupled through the communication network 902 for information exchange, e.g., webpage browsing, webpage refreshing, etc. Although only one terminal 906 and one server 904 are shown in the environment 900, any number of terminals 906 or servers 904 may be included, and other devices may also be included.

The communication network 902 may include any appropriate type of communication network for providing network connections to the server 904 and terminal 906 or among multiple servers 904 or terminals 906. For example, the communication network 902 may include the Internet or other types of computer networks or telecommunication networks, either wired or wireless.

A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other user-side computing device.

A server, as used herein, may refer to one or more server computers configured to provide certain server functionalities, e.g., network data storage and database management. A server may also include one or more processors to execute computer programs in parallel.

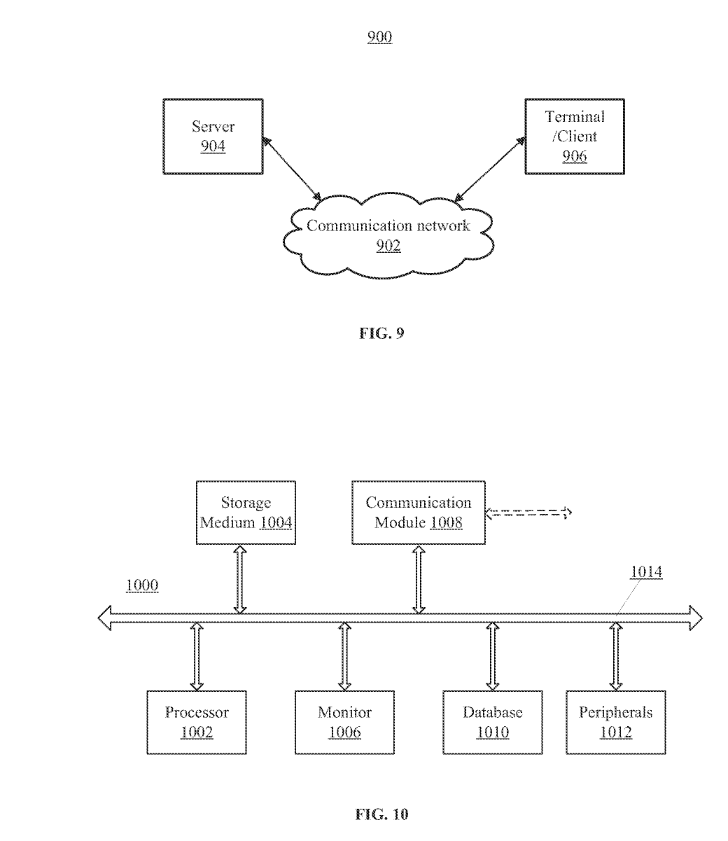

The server 904 and the terminal 906 may be implemented on any appropriate computing platform. FIG. 10 shows a block diagram of an exemplary computing system 1000 capable of implementing the server 904 and/or the terminal 906. As shown in FIG. 10, the exemplary computer system 1000 may include a processor 1002, a storage medium 1004, a monitor 1006, a communication module 1008, a database 1010, peripherals 1012, and one or more bus 1014 to couple the devices together. Certain devices may be omitted and other devices may be included.

The processor 1002 can include any appropriate processor or processors. Further, the processor 1002 can include multiple cores for multi-thread or parallel processing. The storage medium 1004 may include memory modules, e.g., Read-Only Memory (ROM), Random Access Memory (RAM), and flash memory modules, and mass storages, e.g., CD-ROM, U-disk, removable hard disk, etc. The storage medium 1004 may store computer programs for implementing various processes (e.g., obtaining sensor data, data calculations, webpage browsing, webpage refreshing, etc.), when executed by the processor 1002.

The monitor 1006 may include display devices for displaying contents in the computing system 1000, e.g., displaying a webpage in a window of a browser. The peripherals 1012 may include I/O devices, e.g., keyboard and mouse for inputting information by a user. The peripherals may also include certain sensors, such as gravity sensors, acceleration sensors, and other types of sensors.

Further, the communication module 1008 may include network devices for establishing connections through the communication network 902. The database 1010 may include one or more databases for storing certain data and for performing certain operations on the stored data, e.g., webpage browsing, webpage refreshing, etc.

In operation, the terminal 906 may implement certain web browsing improvements, such as improved webpage refreshing or other webpage operations. The terminal 906 may be configured to provide structures and functions correspondingly for related actions and operations. More particularly, during refreshing of a page or webpage, a browser on the terminal 906 can pull data needed for refreshing (i.e., refreshing data) from the server 904 (or a backstage server) according to a URL of the page.

Various embodiments provide methods for refreshing a current page in a browser on a mobile terminal. In an exemplary method, using a gravity-sensing capability of a mobile terminal, acceleration values of the mobile terminal can be obtained when the mobile terminal is shaken externally (e.g., by an external force). The acceleration values can be compared with a preset threshold value. When at least one of the acceleration values exceeds the preset threshold value, refreshing of a current page in the browser on the mobile terminal can be triggered. Thus, the refreshing of the current page in the browser on the mobile terminal can be more convenient for users, and usage value of the mobile terminal can be enhanced.

In various embodiments, the term “a page in a browser” may refer to, for example, information displayed in a window of a browser. The information can be provided by various devices or servers in a network, e.g., the Internet, through websites, file directories, databases, etc. In various embodiments, the page can be a webpage. In some embodiments, the term “a current page” or “the current page” can be interchangeably used with the term “a page” or “the page”, respectively.

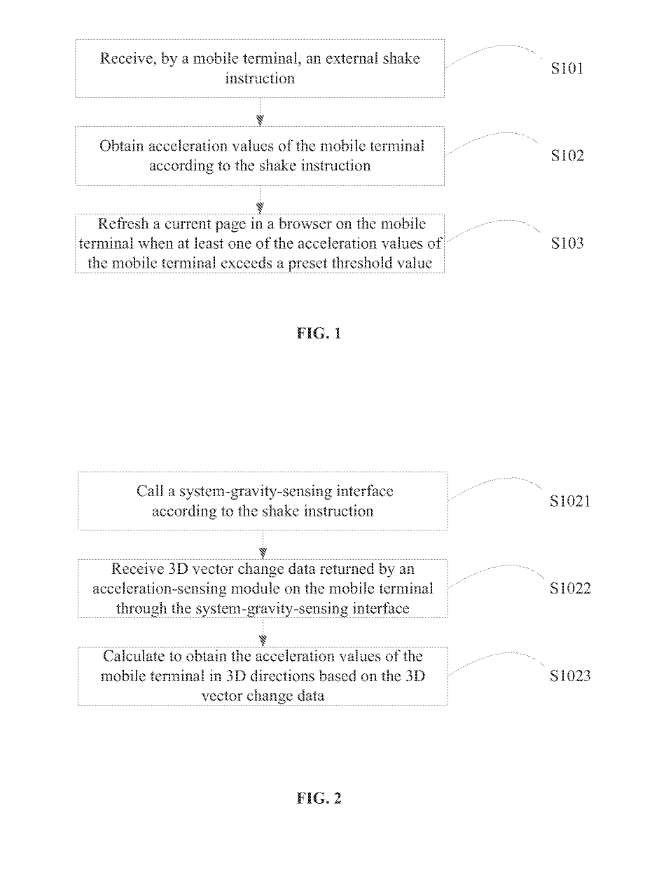

FIG. 1 depicts a flow diagram of an exemplary method for refreshing a page in a browser on a mobile terminal in accordance with various disclosed embodiments. The exemplary method can include the following steps.

In Step S101, a mobile terminal receives an external shake instruction.

In various embodiments, the mobile terminal can have a gravity-sensing capability. That is, an acceleration-sensing module can be set up in the mobile terminal. In various embodiments, a three-axis acceleration sensor can be used as the acceleration-sensing module or as a part of the acceleration-sensing module. At the same time, a gravity-sensing-refresh function on the mobile terminal has already been turned on.

Taking a mobile phone as an example, when a user opens a page on the mobile phone, if the user needs to refresh the current page, he/she can shake the mobile phone to instruct the mobile phone to perform a refreshing operation. The shake motion by the user can thus form the external shake instruction (or the shake instruction).

In Step S102, according to the shake instruction, acceleration values of the mobile terminal are obtained.

In various embodiments, when the user shakes the mobile phone, the acceleration-sensing module on the mobile phone can sense an acceleration of a motion of the mobile phone. In various embodiments, the acceleration can include vector change data in three-dimensional (3D) X-, Y-, and Z-axis directions (i.e., 3D vector change data). By calling a system-gravity-sensing interface, the mobile phone can receive the 3D vector change data returned by the acceleration-sensing module. The mobile phone can thus calculate a velocity change value per unit time in each one of the 3D directions, respectively, and obtain the acceleration values in the 3D directions. For example, an acceleration value can be obtained for each one of the 3D directions, respectively. In various embodiments, the acceleration of the motion of the mobile phone sensed by the acceleration-sensing module can be expressed by the vector change data or the acceleration values in the 3D directions.

The “system-gravity-sensing interface” can refer to, e.g., a connection component within the mobile terminal that can link the acceleration-sensing module with other devices (e.g., the processer) in the mobile terminal, such that the acceleration-sensing module can be controlled by instructions from the other devices in the mobile terminal and can exchange data with the other devices. The “system-gravity-sensing interface” can include suitable hardware and/or software programs for performing corresponding functions.

In various embodiments, the 3D directions may be different from the X-, Y- and Z-axis directions. For example, besides a Cartesian coordinate system, any other coordinate system (e.g., cylindrical, spherical, etc.) may be chosen, and a corresponding set of 3D directions can be used for the 3D vector change data and/or the acceleration values. For example, the 3D vector change data can use the X-, Y- and Z-axis directions as the 3D directions, while the acceleration values can use spherical coordinates (ρ, θ, φ) to express the 3D directions. Appropriate calculations can be implemented correspondingly to convert the 3D vector change data into the acceleration values. The specific coordinate system(s) used for obtaining the 3D vector change data and/or calculating the acceleration values, and how the coordinate system(s) are defined in relation to the mobile terminal's orientation, may be determined by configuration of the acceleration-sensing module, settings of the mobile terminal and the user's preference, and are not limited in the present disclosure.

In Step S103, when at least one of the acceleration values of the mobile terminal exceeds a preset threshold value, the current page in the browser on the mobile terminal is refreshed.

In various embodiments, the calculated acceleration value in each one of the 3D directions can be compared with a preset threshold value. The preset threshold value can be used as the “threshold value”. When the acceleration value in at least one direction exceeds the preset threshold value, or in other words, when at least one of the acceleration values exceeds the preset threshold value, the mobile terminal can recognize that the user has performed a shake operation for refreshing the page. Thus, the refreshing of the current page in the browser on the mobile terminal (e.g., the mobile phone) can be triggered. During the refreshing of the page, the browser can pull refreshing data from a server (or a backstage server) hosting the current page (i.e., pull data from the server again) according to a URL of the current page. After the refreshing data are obtained, the refreshing data can be parsed and rendered, so a refreshed displaying of the page can be accomplished. That is, a refreshed page can thus be displayed.

In one embodiment, the present threshold value is a same value in each of the 3D directions. In another embodiment, the preset threshold value is not limited to one value. For example, each direction can have a preset threshold value, respectively. The preset threshold values can be the same or different in different 3D directions. The acceleration value in one direction can be compared with the preset threshold value in that same direction. The preset threshold values can be determined and preset by the specific settings of the mobile terminal and/or by user preference, and are not limited in the present disclosure.

In yet another embodiment, the current page in the browser on the mobile terminal can refreshed when at least one of the acceleration values of the mobile terminal exceeds a preset threshold value, and the acceleration value can be in any direction, or in a pre-specified direction of the 3D directions. For example, when the acceleration values are expressed using spherical coordinate system coordinates (ρ, θ, φ), it can be pre-specified that, the refreshing is performed if the acceleration value in θ angle exceeds a preset threshold value. So when the user holds the mobile terminal upright and then flips the mobile terminal relative to a horizontal axis (i.e., resulting in a motion in θ angle), the refreshing can be performed. When the user shakes the mobile phone in other manners that do not cause an acceleration value in θ angle to exceed the present threshold value, the refreshing is not performed. In another example, similarly, it can be pre-specified that, the refreshing is performed if the acceleration value in φ angle exceeds a preset threshold value. So when the user holds the mobile terminal upright and then flips the mobile terminal relative to a vertical axis (i.e., resulting in a motion in φ angle), the refreshing can be performed. When the user shakes the mobile phone in other manners that do not cause an acceleration value in φ angle to exceed the present threshold value, the refreshing is not performed. Similar pre-specifying and comparing can be performed when the acceleration values use other coordinate systems, e.g. in X-, Y- and Z-directions. The criteria of comparison (e.g., in how many directions, and in which specific directions, should the acceleration values exceed the preset threshold values in order to trigger the refreshing) can be determined and adjusted by users' preference and/or the settings of the mobile terminal, and are thus not limited in the present disclosure.

FIG. 2 depicts a flow diagram of obtaining acceleration values of a mobile terminal according to a shake instruction, in an exemplary method for refreshing a page in a browser on the mobile terminal in accordance with various disclosed embodiments. In one embodiment, as shown in FIG. 2, Step S102 can include the following steps.

In Step S1021, according to the shake instruction, the system-gravity-sensing interface is called.

In Step S1022, through the system-gravity-sensing interface, the 3D vector change data returned by the acceleration-sensing module on the mobile terminal are received.

In various embodiments, the 3D vector change data can be the vector change data of the mobile terminal in the 3D X-, Y-, and Z-axis directions.

In Step S1023, based on the 3D vector change data, the acceleration values of the mobile terminal in the 3D directions are calculated and obtained.

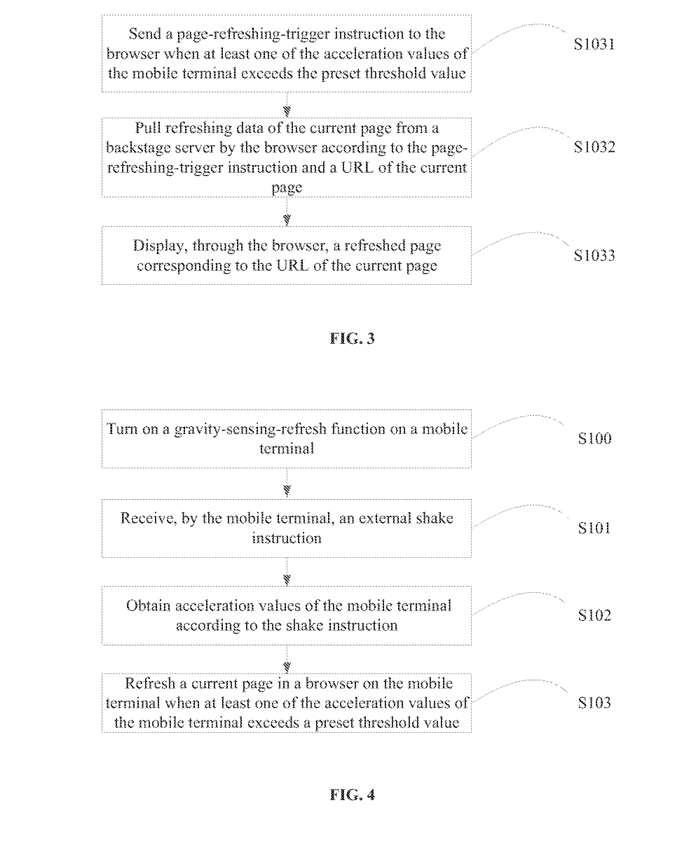

FIG. 3 depicts a flow diagram of refreshing a current page in a browser on a mobile terminal when one of acceleration values of the mobile terminal exceeds a preset threshold, in an exemplary method for refreshing the page in the browser on the mobile terminal in accordance with various disclosed embodiments. As shown in FIG. 3, Step S103 can include the following steps.

In Step S1031, when the acceleration value of the mobile terminal in any one of the directions exceeds the preset threshold value, or when at least one of the acceleration values exceeds the preset threshold value, a page-refreshing-trigger instruction is sent to the browser.

In Step S1032, according to the page-refreshing-trigger instruction and the URL of the current page, the refreshing data of the current page are pulled, through the browser, from the server hosting the current page, in order to refresh the current page.

In Step S1033, a refreshed page corresponding to the URL of the current page is displayed in the browser. That is, rendering and displaying of contents from the URL is performed again, such that the refreshed page can be displayed. In comparison with the current page (or the page), the refreshed page can be a page containing the refreshing data and correspond to the URL of the current page (or the page).

According to various disclosed embodiments, the refreshing of the page in the browser on the mobile terminal can be greatly facilitated for users. Thus, usage value of the mobile terminal can be enhanced.

FIG. 4 depicts a flow diagram of another exemplary method for refreshing a page in a browser on a mobile terminal in accordance with various disclosed embodiments. As shown in FIG. 4, the method is similar to the page refreshing method in FIG. 1, except that, before receiving the external shake instruction as depicted in various disclosed embodiments (e.g., Step S101 as shown in FIG. 1), the method can further include a step as follows.

In Step S100, the gravity-sensing-refresh function on the mobile terminal is turned on.

In comparison with the disclosed method in accordance with various embodiments above (e.g., as shown in FIG. 1), the method in one embodiment (e.g., as shown in FIG. 4) can further include an operation of turning on the gravity-sensing-refresh function on the mobile terminal.

When in use, the gravity-sensing-refresh function may need to be turned on from a browser configuration page on the mobile terminal. An operation of turning on the gravity-sensing-refresh function may depend on the configuration of the mobile terminal. For example, this function may be turned on in the page in the browser window on the mobile terminal. When the gravity-sensing-refresh function is not needed, the gravity-sensing-refresh function may be turned off in order to prevent false operations by the user in a relatively bumpy environment (e.g., on a bus). An operation of turning off the gravity-sensing-refresh function may depend on the configuration of the mobile terminal. For example, the function may be turned off in the page in the browser window on the mobile terminal.

That is, the user can choose to turn on or off the gravity-sensing-refresh function manually such that the gravity-sensing-refresh function can be enabled when the user wants to and be disabled when the environment may cause false determination of shaking Also, the user may change the threshold value of the acceleration calculation such that the threshold value may be set to avoid undesired false determination of shaking instructions. In addition, the terminal may determine whether the gravity-sensing-refresh function is enabled when receiving a shaking instruction. If the gravity-sensing-refresh function is already enabled when receiving the shaking instruction, the terminal proceeds to perform the refreshing process as described. On the other hand, if the gravity-sensing-refresh function is not enabled when receiving the shaking instruction, the terminal may prompt the user as to whether to enable the gravity-sensing-refresh function such that the user may enable the gravity-sensing-refresh function.

According to various disclosed embodiments, the refreshing of the page in the browser on the mobile terminal can be greatly facilitated for users. Thus, usage value of the mobile terminal can be enhanced. In addition, based on users' needs, the gravity-sensing-refresh function can be turned on or off on the mobile terminal, in order to prevent false operations by the user in a bumpy environment. Thus, users can be provided with even further convenience.

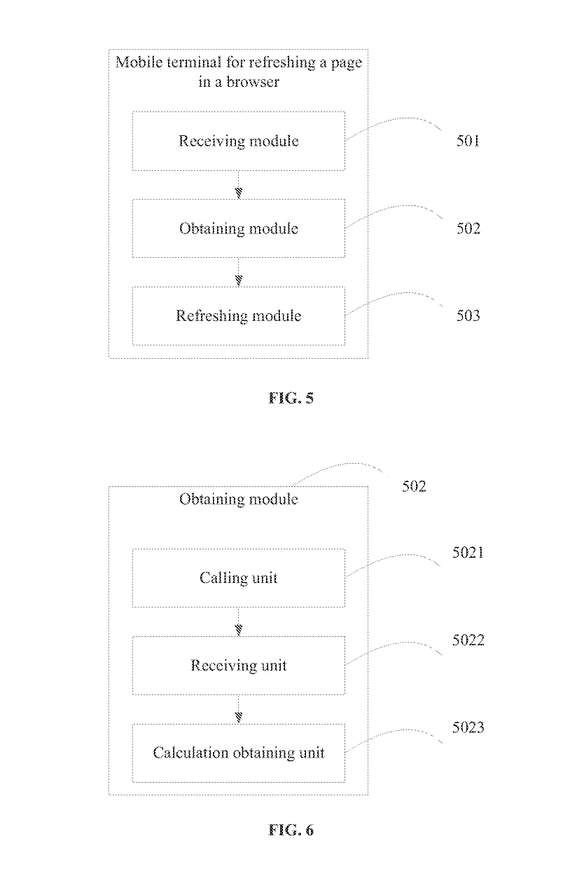

FIG. 5 depicts a structure diagram of an exemplary mobile terminal for refreshing a page in a browser in accordance with various disclosed embodiments. As shown in FIG. 5, the exemplary mobile terminal can include a receiving module 501, an obtaining module 502 and/or a refreshing module 503. Certain modules may be omitted and other modules may be included.

The receiving module 501 is configured to receive an external shake instruction.

The obtaining module 502 is configured to obtain acceleration values of the mobile terminal according to the shake instruction.

The refreshing module 503 is configured to refresh the current page in the browser on the mobile terminal when at least one of the acceleration values of the mobile terminal exceeds a preset threshold value.

In various embodiments, the mobile terminal can have a gravity-sensing capability. That is, an acceleration-sensing module can be set up in the mobile terminal. In various embodiments, a three-axis acceleration sensor can be used as the acceleration-sensing module. At the same time, a gravity-sensing-refresh function on the mobile terminal has already been turned on.

Taking a mobile phone as an example, when a user opens a page on the mobile phone, if the user needs to refresh the current page, he/she can shake the mobile phone to instruct the mobile phone to perform a refreshing operation. The mobile phone can thus receive the external shake instruction through the receiving module 501.

For example, when the user shakes the mobile phone, the acceleration-sensing module on the mobile phone can sense an acceleration of the motion of the mobile phone. In various embodiments, the acceleration can include vector change data in 3D X-, Y-, and Z-axis directions. By calling a system-gravity-sensing interface, the obtaining module 502 of the mobile phone can receive the 3D vector change data returned by the acceleration-sensing module. The mobile phone can thus calculate a velocity change value per unit time in each one of the 3D directions, respectively, and obtain the acceleration values for the 3D directions. For example, one acceleration value can be obtained for each 3D direction, respectively.

Next, the refreshing module 503 can compare the calculated acceleration value in each one of the 3D directions with a preset threshold value. The preset threshold value can be used as the “set threshold value”. When the acceleration value in at least one direction exceeds the preset threshold value, or in other words, when at least one of the acceleration values exceeds the preset threshold value, the refreshing module 503 can recognize that the user has performed a shake operation for refreshing the page. Thus, the refreshing of the current page in the browser on the mobile terminal (e.g., the mobile phone) can be triggered. During the refreshing of the page, the browser can pull refreshing data from a server hosting the current page (i.e., pull data from the server again) according to a URL of the current page. After the refreshing data are obtained, the refreshing data can be parsed and rendered, so a refreshed displaying of the page can be accomplished. That is, a refreshed page can thus be displayed.

FIG. 6 depicts a structure diagram of an obtaining module of an exemplary mobile terminal for refreshing a page in a browser in accordance with various disclosed embodiments. In various embodiments, e.g., as shown in FIG. 6, the obtaining module 502 can include a calling unit 5021, a receiving unit 5022, and/or a calculation obtaining unit 5023. Certain units may be omitted and other units may be included.

The calling unit 5021 is configured to call the system-gravity-sensing interface according to the shake instruction.

The receiving unit 5022 is configured to, through the system-gravity-sensing interface, receive the 3D vector change data returned by the acceleration-sensing module on the mobile terminal. In various embodiments, the 3D vector change data can be the vector change data of the mobile terminal in the 3D X-, Y-, and Z-axis directions.

The calculation obtaining unit 5023 is configured to calculate and obtain the acceleration values of the mobile terminal in the 3D X-, Y-, and Z-axis directions based on the 3D vector change data.

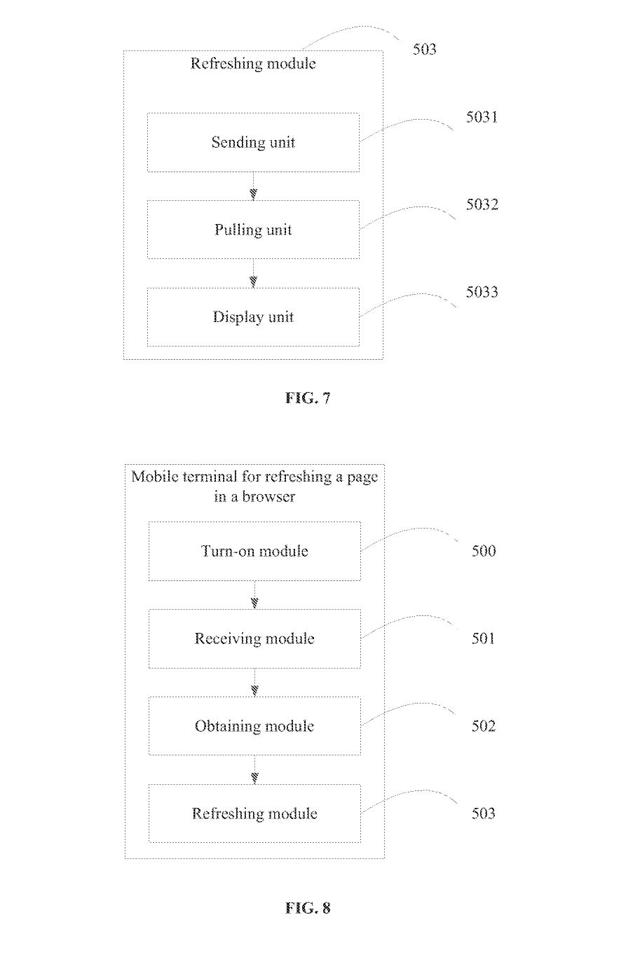

FIG. 7 depicts a structure diagram of a refreshing module of an exemplary mobile terminal for refreshing a page in a browser in accordance with various disclosed embodiments.

In various embodiments, e.g., as shown in FIG. 7, the refreshing module 503 may include a sending unit 5031, a pulling unit 5032, and/or a display unit 5033. Certain units may be omitted and other units may be included.

The sending unit 5031 is configured to send a page-refreshing-trigger instruction to the browser when the acceleration value of the mobile terminal in any one of the directions exceeds the preset threshold value, or when at least one of the acceleration values exceeds the preset threshold value.

The pulling unit 5032 is configured to pull the refreshing data of the current page, through the browser, from the server hosting the current page, according to the page-refreshing-trigger instruction and the URL of the current page.

The display unit 5033 is configured to, through the browser, display a refreshed page corresponding to the URL of the current page. That is, rendering and displaying of contents from the URL is performed again, such that the refreshed page can be displayed.

According to various disclosed embodiments, the refreshing of the page in the browser on the mobile terminal can be greatly facilitated for users. Thus, usage value of the mobile terminal can be enhanced.

FIG. 8 depicts a structure diagram of another exemplary mobile terminal for refreshing a page in a browser in accordance with various disclosed embodiments. In various embodiments, e.g., as shown in FIG. 8, the mobile terminal can further include a turn-on module 500.

The turn-on module 500 is configured to turn on the gravity-sensing-refresh function on the mobile terminal. In comparison with the disclosed method in accordance with various embodiments above (e.g., as shown in FIG. 5), the mobile terminal in one embodiment (e.g., as shown in FIG. 8) can further include the turn-on module 500 to perform an operation of turning on the gravity-sensing-refresh function on the mobile terminal.

When in use, the gravity-sensing-refresh function may need to be turned on from a browser configuration page on the mobile terminal. An operation of turning on the gravity-sensing-refresh function may depend on the configuration of the mobile terminal. For example, this function may be turned on in the page in the browser window on the mobile terminal. When the gravity-sensing-refresh function is not needed, the gravity-sensing-refresh function may be turned off in order to prevent false operations by the user in a relatively bumpy environment (e.g., on a bus). An operation of turning off the gravity-sensing-refresh function may depend on the configuration of the mobile terminal. For example, the function may be turned off in the page in the browser window on the mobile terminal.

For example, when receiving a shaking instruction, the terminal may determine whether the gravity-sensing-refresh function is enabled. In one embodiment, the turn-on module 500 can be configured to make such a determination. If the gravity-sensing-refresh function is already enabled when receiving the shaking instruction, the terminal proceeds to perform the refreshing process as described. On the other hand, if the gravity-sensing-refresh function is not enabled when receiving the shaking instruction, the turn-on module 500 may prompt the user as to whether to enable the gravity-sensing-refresh function, such that the user may enable the gravity-sensing-refresh function through the turn-on module 500.

As disclosed herein, the disclosed methods and mobile terminal may be accomplished by other means. The mobile terminals as depicted above in accordance with various embodiments are exemplary only. For example, the disclosed modules/units can be divided based on logic functions. In actual implementation, other dividing methods can be used. For instance, multiple modules or units can be combined or integrated into another system, or some characteristics can be omitted or not executed, etc.

In addition, each functional module/unit in various disclosed embodiments can be integrated in a processing unit, or each module/unit can exist separately and physically, or two or more modules/units can be integrated in one unit. The integrated units as disclosed above can be implemented in the form of hardware and/or in the form of software functional unit(s).

When the integrated modules/units as disclosed above are implemented in the form of software functional unit(s) and sold or used as an independent product, the integrated units can be stored in a computer readable storage medium. Therefore, the whole or part of the essential technical scheme of the present disclosure can be reflected in the form of software product(s). The computer software product(s) can be stored in a storage medium, which can include a plurality of instructions to enable a computing device (e.g., a mobile terminal, a personal computer, a server, a network device, etc.) to execute all or part of the steps as disclosed in accordance with various embodiments of the present disclosure. The storage medium can include various media for storing programming codes including, for example, U-disk, portable hard disk, ROM, RAM, magnetic disk, optical disk, etc.

According to various disclosed embodiments, the refreshing of the page in the browser on the mobile terminal can be greatly facilitated for users. Thus, usage value of the mobile terminal can be enhanced. In addition, based on users' needs, the gravity-sensing-refresh function can be turned on or off on the mobile terminal, in order to prevent false operations by the user in a bumpy environment. Thus, users can be provided with even further convenience.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods and mobile terminals can be used in a variety of Internet applications. In an exemplary method, when a mobile terminal is shaken externally (e.g., by an external force), acceleration values of the mobile terminal can be obtained using a gravity-sensing capability of the mobile terminal,. When at least one of the acceleration values of the mobile terminal exceeds a preset threshold value, the page in the browser on the mobile terminal can be refreshed. Thus, the refreshing of the current page in the browser on the mobile terminal can be more convenient for users, and usage value of the mobile terminal can be enhanced.

Furthermore, the user can choose to turn on or off the gravity-sensing-refresh function on the mobile terminal, in order to prevent false operations by the user in a bumpy environment. That is, the gravity-sensing-refresh function can be enabled when the user wants to, and be disabled when the environment may cause false determination of shaking Thus, users can be provided with even further convenience.

What is claimed is:

1. A method for refreshing a page in a browser on a mobile terminal, implemented by the mobile terminal, comprising:
receiving an external shake instruction from a user;
obtaining acceleration values of the mobile terminal according to the shake instruction; and
refreshing the page in the browser on the mobile terminal when at least one of the acceleration values of the mobile terminal exceeds a preset threshold value.

2. The method according to claim 1, wherein the obtaining of the acceleration values of the mobile terminal according to the shake instruction includes:
calling a system-gravity-sensing interface according to the shake instruction;
receiving, through the system-gravity-sensing interface, three-dimensional (3D) vector change data returned by an acceleration-sensing module on the mobile terminal; and
calculating to obtain the acceleration values of the mobile terminal in 3D directions, respectively, based on the 3D vector change data.

3. The method according to claim 2, wherein the refreshing of the page in the browser on the mobile terminal, when at least one of the acceleration values of the mobile terminal exceeds the preset threshold value, includes:
sending a page-refreshing-trigger instruction to the browser when at least one of the acceleration values of the mobile terminal exceeds the preset threshold value;
pulling refreshing data of the page from a backstage server through the browser, according to the page-refreshing-trigger instruction and a Uniform Resource Locator (URL) of the page; and
displaying, through the browser, a refreshed page corresponding to the URL of the page.

4. The method according to claim 1, wherein before receiving the external shake instruction, the method further includes:
turning on a gravity-sensing-refresh function on the mobile terminal.

5. The method according to claim 4, further including:
turning off the gravity-sensing-refresh function on the mobile terminal when the gravity-sensing-refresh function is not needed by the user.

6. The method according to claim 5, wherein after turning off the gravity-sensing-refresh function on the mobile terminal, the method further includes:
when the shaking instruction is received, prompting the user as to whether to enable the gravity-sensing-refresh function; and
when the user chooses to enable the gravity-sensing-refresh function, turning on the gravity-sensing-refresh function on the mobile terminal.

7. The method according to claim 2, wherein the acceleration-sensing module includes a three-axis acceleration sensor.

8. A mobile terminal for refreshing a page in a browser, comprising:
a receiving module configured to receive an external shake instruction from a user;
an obtaining module configured to obtain acceleration values of the mobile terminal according to the shake instruction; and
a refreshing module configured to refresh the page in the browser on the mobile terminal when at least one of the acceleration values of the mobile terminal exceeds a preset threshold value.

9. The mobile terminal according to claim 8, wherein the obtaining module includes:
a calling unit configured to call a system-gravity-sensing interface according to the shake instruction;
a receiving unit configured to, through the system-gravity-sensing interface, receive 3D vector change data returned by an acceleration-sensing module on the mobile terminal; and
a calculation obtaining unit configured to calculate to obtain the acceleration values of the mobile terminal in 3D directions, respectively, based on the 3D vector change data.

10. The mobile terminal according to claim 9, wherein the refreshing module includes:
a sending unit configured to send a page-refreshing-trigger instruction to the browser when at least one of the acceleration values of the mobile exceeds the preset threshold value;
a pulling unit configured to pull refreshing data of the page from a backstage server through the browser, according to the page-refreshing-trigger instruction and a URL of the page; and
a display unit configured to, through the browser, display a refreshed page corresponding to the URL of the page.

11. The mobile terminal according to claim 8, further including:
a turn-on module configured to turn on a gravity-sensing-refresh function on the mobile terminal.

12. The mobile terminal according to claim 11, wherein the gravity-sensing-refresh function is turned off on the mobile terminal when the gravity-sensing-refresh function is not needed by the user.

13. The mobile terminal according to claim 12, wherein after the gravity-sensing-refresh function on the mobile terminal is turned off, the turn-on module is further configured to:
when the shaking instruction is received, prompt the user as to whether to enable the gravity-sensing-refresh function; and
turn on the gravity-sensing-refresh function on the mobile terminal when the user chooses to enable the gravity-sensing-refresh function.

14. The mobile terminal according to claim 9, wherein the acceleration-sensing module includes a three-axis acceleration sensor.
